(19) United States
(12) Patent Application Publication
(10) Pub. No.: US 2007/0217624 A1
(43) Pub. Date: Sep. 20, 2007

(54) Audio System

(75) Inventor: Christophe Marc Macours, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,076

(22) PCT Filed: May 10, 2005
(86) PCT No.: PCT/IB05/51517

§ 371 Date: Nov. 14, 2006

(30) Foreign Application Priority Data
May 17, 2004 (EP) 04102158.5

(51) Int. Cl. H04B 15/00

(52) U.S. Cl. 381/94.2; 381/94.1

(57) ABSTRACT

The invention relates to an audio system and a method for the stereo enhancement of decoded stereo signals. When decoded stereo signals are stereo enhanced, artefacts can be unmasked and can thus become audible. The invention tries to achieve that a stereo enhancement for decoded stereo signals which is possible without restrictions and without artefacts from becoming audible. It is suggested that a frequency range of the stereo signal is defined in which artefacts might be unmasked due to the stereo enhancement. The boost which is applied to the first of a total of two mono signals of which the stereo signal is composed of (the first signal might be the S-signal in the mid/side representation) is determined by an artefact remover. This makes it possible to attenuate the first mono signal S within the above frequency range. As a net result, the first mono signal S is not boosted within this frequency range, such that artefacts are not unmasked.

The invention relates to an audio system for the stereo enhancement of decoded stereo signals and a method for stereo enhancing decoded stereo signals.

Audio signals in stereo quality are often post-processed to improve the acoustic impression for the user. Post-processing might improve the three-dimensional impression or the depth of the audio signals, or it might achieve a widening of the audio signal.

When songs are exchanged among computers by using the Internet, they are routinely encoded to generate compressed audio signals. In this respect encoded audio formats such as MP3, WMA or AAC are widespread nowadays. The encoded signals must be decoded in order to listen to them. This means that quite often decoded stereo signals are post-processed.

As encoding and decoding of audio signals is accompanied by losses such that the decoded signal contains less information than the original signal, the post-processing of decoded signals is often accompanied with audible artefacts which specifically stem from the losses of the encoding procedure.

PHNL020597 discloses an audio system for post-processing audio signals which detects audible noise after post-processing, and intends to prevent this noise from becoming audible by adjusting the degree of post-processing. This approach has the disadvantage that the post-processing can't be performed completely, such that the quality of the audio signal will not become as good as desired.

It is an object of the present invention to provide an audio system and a method for stereo enhancing a decoded stereo signal in which arbitrary stereo enhancement can be performed without restrictions and without the generation of audible artefacts.

According to the present invention the above-mentioned objects are achieved by providing the features defined in the independent claims. Preferred embodiments according to the invention additionally comprise the features of the sub-claims.

The invention rests on the idea that in many cases the stereo signal is not encoded and subsequently decoded in the way that the left channel (L) and the right channel (R) of a stereo signal are encoded or decoded. Instead, most codecs use other representations of the stereo signal. In general, the stereo input of an encoder is split into a first mono signal and a second mono signal which are different from the left channel and the right channel. The first mono signal and the second mono signal are encoded separately within the encoder and an encoded stereo signal is outputted. Correspondingly a decoder receives an encoded stereo signal, generates a decoded first signal and a decoded second signal, and outputs a decoded stereo signal.

As an example, the stereo signal can be represented in the mid/side format which can be expressed by the following equations:

$$S = \frac{L - R}{2} M = \frac{L + R}{2}$$

Accordingly, an encoder internally generates S and M, encodes S and M separately, and outputs an encoded stereo signal. Correspondingly, a decoder internally decodes S and M separately, and outputs a decoded stereo signal. The underlying reason for this approach is that in this way a higher quality is achieved in the encoding process.

In the following the description will often refer to the case that encoders and decoders make use of the mid/side representation. In this case the first mono signal is the S-signal, and the second mono signal is the M-signal. It should be emphasised however that this is only a special case, and that the invention is not restricted to this kind of representation. It is also possible that, for example, decoders and encoders perform one channel stereo encoding/decoding.

Applying stereo enhancement to decoded stereo signals leads to audible artefacts which originate from the fact that the decoded signal and the original signal contain a different amount of information. More specifically, many artefacts have its origin in the decoded S-signal only. Stereo enhancement is then responsible that the artefacts become audible.

The audio system which is suggested to overcome the problem of artefacts which become audible due to the stereo enhancement of decoded stereo signals firstly comprises a stereo enhancer to which a stereo signal A is transferable to. The stereo enhancer is arranged to output a modified stereo signal A′.

Furthermore, the audio system comprises an artefact remover which is arranged to receive the stereo signal A, and is arranged to receive the modified stereo signal A′. The artefact remover determines a value E1 of a parameter P of the stereo signal A, and determines a value E2 of the same parameter P of the modified stereo signal A′. The artefact remover then outputs an artefact-free stereo signal A″ by using the two values E1 and E2 of the parameter P.

The parameter P is chosen in such a way that the two values E1 and E2 which are determined by the artefact remover can be used to calculate the value E3 of a second parameter P′, the second parameter P′ being representative for the stereo enhancement to which the modified stereo signal A′ was subjected to.

For the present invention an arbitrary stereo enhancer can be chosen. In many cases such a stereo enhancer is arranged to split the input stereo signal A into an S-signal and an M-signal as described above. The stereo enhancer then modifies S and possibly M in order to improve acoustic aspects of the stereo signal A, and outputs a modified stereo signal A′. In the easiest case S is subjected to a linear gain. In this case the second parameter P′ can be chosen to be the gain to which S was subjected to.

In order to take this into account the artefact remover is preferably arranged to decompose the stereo signal A into a first mono signal S and a second mono signal M, and is correspondingly arranged to decompose the modified stereo signal A′ into a first mono signal S′ and a second mono signal M′.

The parameter P can be chosen to be the energy of a first mono signal for all frequencies within a predetermined frequency range. If the artefact remover splits a stereo signal A into a first mono signal S and a second mono signal M, then the parameter P can be chosen to be the energy of the first mono signal S for all frequencies within a predetermined frequency range. A predetermined frequency range in this sense can also mean all frequencies above a predetermined threshold frequency.

If the parameter P is chosen to be such an energy, the value of this energy of the first mono signal S of the stereo signal A might be E1, and the value of the energy of the first mono signal S′ of the modified stereo signal A′ might be E2. In this case the ratio E2/E1 represents the value E3 of a second parameter P′. P′ is characteristic for the stereo enhancement to which the modified stereo signal A′ was subjected to. The reason is that P′ represents the gain which has been applied by the stereo enhancer to all frequencies of the first mono signal S within the above-mentioned predetermined frequency range, and E3 is the value of this gain.

Although the above explanations only refer to a single frequency range, it is also possible to define a multitude of frequency ranges. In this case the frequency spectrum of the corresponding signal is divided into a multitude of frequency ranges. For each frequency range, the energy of the corresponding signal is determined. In this case it is possible to take situations into account in which the gain which has been applied to the first mono signal S′ is not constant for all frequencies, but is instead frequency dependent. This allows for a more accurate determination of the gain and yields a better acoustic impression.

In order to determine the above-mentioned energies the artefact remover comprises two units which are arranged to determine the energy of all frequencies of the corresponding signal within a predetermined frequency range, and for example above a predetermined threshold frequency. This energy determination unit might be an RMS-block (root mean square), or devices equivalent to such an RMS-block.

Experiments have shown that good results can be achieved by using a threshold frequency which has a value between about 4 kHz and about 8 kHz.

As the values E1 and E2 of the first parameter P make it possible to calculate the value E3 of a second parameter P′, the second parameter P′ being characteristic for the stereo enhancement to which the stereo signal A′ was subjected to. It is possible for the artefact remover to generate an artefact-free stereo signal A″ by using the value E3 of this parameter P′, or in other words by using the value E1 obtained by the first energy determination unit and the value E2 obtained by the second energy determination unit.

If a gain, for example a linear gain, has been applied by the stereo enhancer to the first mono signal S for all frequencies within a predetermined frequency range, then the artefact remover can use an attenuator for attenuating all frequencies of the first mono signal S′ within the same frequency range by a factor. This factor is chosen to be the ratio E2/E1. This approach makes it possible to compensate for the gain applied to all frequencies of a predetermined frequency range of the first mono signal S by applying an appropriate attenuation to the same frequencies of the first mono signal S′. If, for example, a gain of 5 dB has been applied by the stereo enhancer to this frequency range of the first mono signal S, then this frequency range of the modified first mono signal S′ is attenuated by −5 dB. As a net result, this frequency range of the first mono signal S is not altered at all which avoids an unmasking of artefacts.

The attenuator can be chosen to be a shelving filter which applies a unitary linear gain to all frequencies of the first mono signal S up to a threshold frequency, and which has a corresponding drop of the gain at the threshold frequency.

These and other aspects of the invention will be apparent from and elucidated with reference to the embodiments described thereafter.

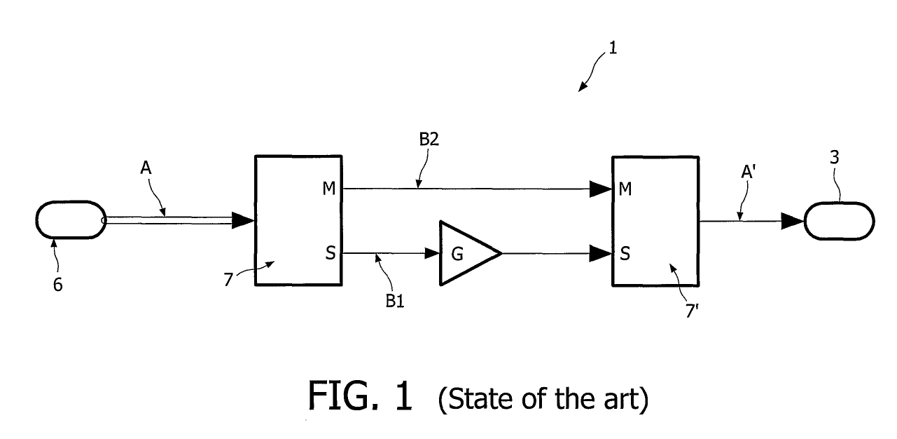

FIG. 1 sows a stereo enhancer known in the prior art which applies a linear gain to S.

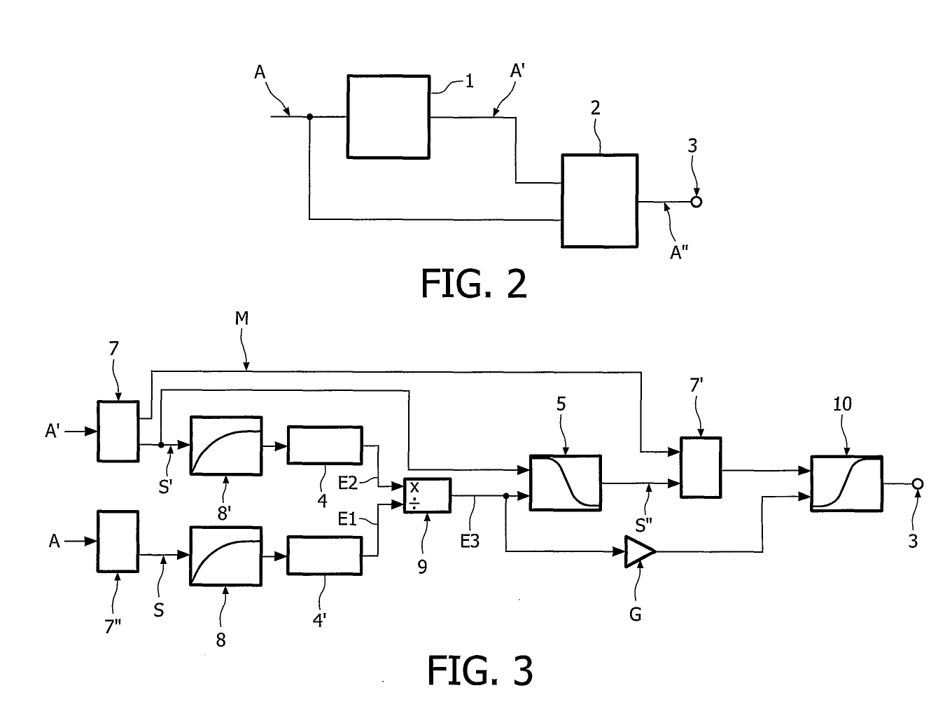

FIG. 2 is a block diagram for the general solution.

FIG. 3 is a detailed block diagram of the artefact remover.

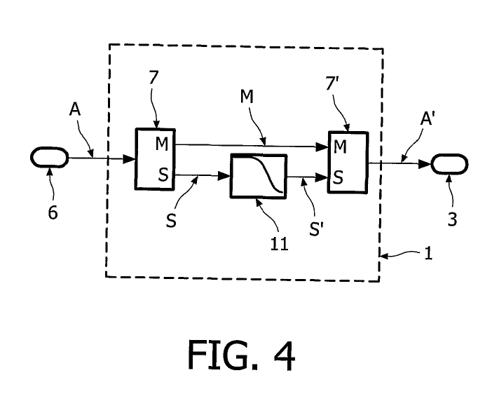

FIG. 4 is a block diagram for an artefact-free stereo enhancer.

FIG. 1 shows a stereo enhancer 1 according to the prior art. A decoder 6 outputs a stereo audio signal A serving as an input for splitting unit 7. In the splitting unit 7 the stereo signal A is splitted into mid/side signals, namely the signal S and the signal M. The signal S is subjected to a linear gain G, whereas the signal M is not boosted. The second splitting unit 7′ rejoins the boosted S-signal and the M-signal to generate a modified stereo audio signal A′, which is sent to an output 3, which may be connected e.g. to a loudspeaker, storage device, etc.

FIG. 2 shows a block diagram illustrating the general concept of the invention. A decoded stereo signal A is transferred to a stereo enhancer 1. The stereo enhancer 1 contains a splitting unit 7 (not shown) to generate two mono signals S and M. Only one of the mono signals are modified, such that the stereo output signal A′ is composed of an unchanged mono signal M and a modified mono signal S′.

The artefact remover 2 has two inputs: one input is the modified stereo signal A′, the second input is the stereo signal A. The artefact remover 2 determines two values E1 and E2 of a predetermined parameter P: the value E1 of the stereo signal A, and the value E2 of the modified stereo signal A′. These two values E1 and E2 are used by the artefact remover 2 to generate an artefact-free stereo signal A″. The audio system has an output 3 where A″ is outputted.

FIG. 3 is a detailed block diagram of the artefact remover 2. A decoded stereo signal A serves as an input for a splitting unit 7″. The stereo signal A has not been subjected to a stereo enhancement process before. The splitting unit 7″ splits the stereo signal A into an M-signal and an S-signal. Splitting unit 7″ outputs the S-signal. The M-signal generated by splitting unit 7″ is not used for the purposes of generating an artefact-free stereo signal, and is thus of no interest for the further discussion.

A decoded stereo signal A″ which has been stereo enhanced before (not shown) serves as an input for the splitting unit 7. It generates a signal S′ with audible artefacts. Furthermore it generates an M-signal which is directly fed into the unit 7′ which rejoins an M-signal with the corresponding signal S″ as will be explained below.

The S-signals S′ and S which are generated by splitting units 7 and 7″ are each fed into identical high pass filters 8′ and 8. These filters 8, 8′ each have a threshold frequency of 6 kHz. Afterwards the two S-signals are analysed by the RMS-blocks 4 and 4′.

The RMS-block 4 determines the energy E2 for the stereo enhanced signal S′ for all frequencies above the threshold frequency of 6 kHz. Correspondingly, RMS-block 4′ determines the energy E1 of the signal S originating from stereo signal A for all frequencies above the same threshold frequency of 6 kHz.

Comparison unit 9 compares the two values of E1 and E2 in order to calculate the value E3 of an additional parameter P′ representative of the stereo enhancement process to which stereo signal A′ was subjected to. In this case E3 is equal to the ratio E2/E1 which represents the gain applied by the stereo enhancer to signal A. The ratio E2/E1 can be calculated to determine the attenuation which is necessary to attenuate signal S′ by means of attenuator 5. Attenuator 5 generates the attenuated S-signal S″.

The net result after the attenuation by attenuator 5 is that the signal S of the decoded stereo signal is the same for all frequencies above 6 kHz as the signal S″. This ensures that the amplification of the S-signal doesn't lead to an unmasking of artefacts such that they become audible.

An optional treble compensation unit 10 might be added, for which S′ is amplified by means of gain G. Treble compensation unit 10 being part of the stereo system has an output 3 for the artefact-free stereo signal A″, which is composed of the unchanged M-signal and S″.

FIG. 4 is a block diagram of an artefact-free stereo enhancer 1 corresponding to FIG. 1. Decoder 6 outputs a stereo signal A which is fed into the stereo enhancer 1. The stereo enhancer 1 comprises a splitting unit 7′ to generate two mono signals M and S. Instead of a linear gain applied to S this mono signal is fed into a shelving filter 11. This filter 11 applies a linear gain to all frequencies below a threshold frequency, which in this case is 6 kHz. Furthermore the filter 11 shows a sharp decline of the boost for frequencies above the threshold frequency. A second splitting unit 7′ uses the mono signals S′ and M to generate an artefact-free stereo signal A′ for output 3

List of Reference Numerals

1 stereo enhancer
2 artefact remover
3 output
4 energy determination unit
5 attenuator
6 decoder
7 splitting unit
8 high pass filter
9 comparison unit
10 treble compensation unit
11 stereo enhancing shelving filter
A decoded stereo signal
A′ modified stereo signal
S first mono signal into which the audio signal A can be decomposed
M second mono signal into which the audio signal A can be decomposed
S′ first mono signal into which the audio signal A′ can be decomposed
M′ second mono signal into which the audio signal A′ can be decomposed
G gain

1. Audio system for stereo enhancing decoded stereo signals,
comprising
a stereo enhancer (1) to which a stereo signal (A) is transferable to,
the stereo enhancer (1) being arranged to output a modified stereo signal (A′),
an artefact remover (2) arranged to receive the stereo
signal (A) and to receive the modified stereo signal (A′),
the artefact remover (2) arranged to determine a value (E1) of a parameter of the stereo signal (A), and to determine a value (E2) of the same parameter of the modified stereo signal (A′),
the artefact remover (2) arranged to output an artefact—
free stereo signal (A″) by using the two values (E1, E2) of the parameter.

2. Audio system according to claim 1, characterized in that the artefact remover (2) is arranged to decompose the first stereo signal (A) into a first mono signal (S) and a second mono signal (M), and is arranged to decompose the modified stereo signal (A′) into a first mono signal (S′) and a second mono signal (M′).

3. Audio system according to claim 2, characterized in that the values (E1, E2) of the parameter are determined from the first mono signal (S) of the stereo signal (A) and the first mono signal (S′) of the modified stereo signal (A′).

4. Audio system according to claim 2, characterized in that the parameter is the energy of the first mono signal (S, S′) for all frequencies within a predetermined frequency range.

5. Audio system according to claim 1, characterized in that the artefact remover (2) comprises a first unit (4) arranged to determine the energy (E1) of the stereo signal (A) for frequencies above a predetermined threshold frequency (TF), and a second unit (4′) arranged to determine the energy (E2) of the modified stereo signal (A′) for frequencies above the same threshold frequency (TF).

6. Audio system according to claim 5, characterized in that the threshold frequency (TF) has a value between about 4 kHz and about 8 kHz.

7. Audio system according to claim 1, characterized in that the artefact remover (2) comprises an attenuator (5) for attenuating all frequencies of the modified stereo signal (A′) within the predetermined frequency range by a factor, this factor being the ratio of the value (E2) and the value (E1).

8. Audio system according to claim 7, characterized in that the attenuator (5) is a shelving filter.

9. Method for stereo enhancing decoded stereo signals, including the steps of:
a) stereo enhancing a stereo signal (A) and thereby generating a modified stereo signal (A′),
b) determining two values (E1, E2) of a predetermined parameter,
b1) the first value (E1) being obtained by determining the parameter from the stereo signal (A),
b2) and the second value (E2) being obtained by determining the same parameter from the modified stereo signal (A′),
c) generating an artefact-free stereo signal (A″) by using the first value (E1) and the second value (E2) of the parameter.

10. Method according to claim 9, characterized in that the artefact remover (2) decomposes the stereo signal (A) into a first mono signal (S) and a second mono signal (M), and decomposes the modified stereo signal (A′) into a first mono signal (S′) and a second mono signal (M′).

11. Method according to claim 10, characterized in that the values (E1, E2) of the parameter are determined from the first mono signal (S) of the stereo signal (A) and the first mono signal (S′) of the modified stereo signal (A′).

12. Method according to claim 9, characterized in that the parameter is chosen to be the energy of the first mono signal (S, S′) for all frequencies within a predetermined frequency range.

13. Method according to claim 9, characterized in that all frequencies of the first mono signal (S′) of the modified stereo signal (A′) above the predetermined threshold value (TF) are attenuated by a factor, the factor being the ratio of the second energy (E2) and the first energy (E1).

14. Method according to claim 13, characterized in that all frequencies of the modified stereo signal (A′) above a threshold frequency of about 4 kHz to about 8 kHz are attenuated.
